(19) United States
(12) Patent Application Publication
(10) Pub. No.: US 2008/0143833 A1
(43) Pub. Date: Jun. 19, 2008

(54) Image Pickup Device and Image Pickup Method

(76) Inventors: Tatsumi Yanai, Tokyo-to (JP); Ken Oizumi, Tokyo-to (JP)

Correspondence Address: YOUNG & BASILE, P.C., 3001 WEST BIG BEAVER ROAD, SUITE 624, TROY, MI, 48084, US

(21) Appl. No.: 10/574,131

(22) PCT Filed: Nov. 23, 2005
(86) PCT No.: PCT/IB05/03522

§ 371 Date: Mar. 30, 2006

(30) Foreign Application Priority Data
Nov. 26, 2004 (JP) 2004-342457
Apr. 5, 2005 (JP) 2005-108726

(51) Int. Cl. H04N 7/18

(52) U.S. Cl. 348/148; 348/E07.085

(57) ABSTRACT

To provide an image pickup device and image pickup method for displaying the optimum range of observation without relying on the conditions in which the vehicle enters the road or the installation situation of the plurality of cameras. To provide a plurality of periphery image pickup means 10 and 11 that obtain images of the periphery of a vehicle wherein periphery image pickup means 10 and 11 that obtain the images displayed for the driver of the vehicle and the image range of the images obtained by periphery image pickup means 10 and 11 that are displayed to the driver of the vehicle are selected.

### CROSS-REFERENCE TO RELATED APPLICATIONS

The present application claims priority under 35 U.S.C. § 119 of Japanese Application No. 2004-342457, filed on Nov. 26, 2004, and Japanese Patent Application No. 2005-108726, filed on Apr. 5, 2005, the entire content of which is expressly incorporated by reference herein.

### FIELD

The present invention pertains to an image pickup device and an image pickup method, in particular to an image pickup device and image pickup method that obtains images of the periphery of a vehicle and displays them to the driver of the vehicle.

### BACKGROUND

Periphery visual confirmation devices for vehicles in which cameras are placed to the front and the rear of a vehicle to take images of the field of vision on both sides of the vehicle and display images of blind spots in the periphery of the vehicle onto a display are known as conventional technology. (For example, refer to Japanese Unexamined Patent Application Publication No. 3468661).

In the '661 application, not only is technology disclosed in which the aforementioned function is enabled via operation of a switch, but technology is also disclosed whereby images of side views of the field of vision are displayed in accordance with the environment in which the vehicle is traveling as indicated by driving history and navigation information.

### SUMMARY

However, in (Japanese Application No. 3468661), since the range in which the camera can pickup images is limited, the best images of blind spots cannot be displayed in accordance with the conditions in which the vehicle enters the road. For example, if a vehicle enters the road diagonally, the best range of observation cannot be displayed. In addition, even if multiple cameras are installed, the best range of observation still may not be displayed.

The present invention is characterized in that the main point is to provide an image pickup device provided with a plurality of periphery image pickup means for obtaining images of the periphery of a vehicle, wherein said periphery image pickup means that obtain images to display for the driver of the vehicle and the image range of the images obtained by the periphery image pickup means that are displayed to the driver of the vehicle are selected in accordance with the conditions in which the vehicle enters a road that intersects the direction in which the vehicle is traveling.

According to the present invention, an image pickup device and image pickup method are provided for displaying images of the best range of observation without relying on the conditions in which a vehicle enters the road or on the installation of multiple cameras.

### BRIEF DESCRIPTION OF DRAWINGS

FIG. 1 is a block diagram showing the image pickup device pertaining to Embodiment 1 of the present invention;

FIG. 2 is a flow chart showing the process for the image pickup device shown in FIG. 1;

FIG. 3 is a block diagram showing the image pickup device pertaining to Embodiment 2 of the present invention;

FIG. 4 is a flow chart showing the process for the image pickup device shown in FIG. 3;

FIG. 5 is a block diagram showing the image pickup device pertaining to Embodiment 3 of the present invention;

FIG. 6 is a flow chart showing the process for the image pickup device shown in FIG. 5;

FIG. 7(a) is a plan view showing an illustration of a vehicle provided with the image pickup device shown in FIG. 1 in which the vehicle is entering the road at a diagonal in a forward-moving direction;

FIG. 7(b) is a plan view of an illustration of a vehicle provided with the image pickup device shown in FIG. 3 in which the vehicle is entering the road at a diagonal in a forward-moving direction;

FIG. 7(c) is a plan view showing an illustration of a vehicle provided with the image pickup device shown in FIG. 5 in which the vehicle is entering the road at a diagonal in a reverse direction;

FIG. 8 is a plan view of the illustration shown in FIG. 7(a) showing the arrangement of the wide-angle cameras and their image pickup range;

FIG. 9 is a plan view of the illustrations shown in FIGS. 7(b) and (c) showing the arrangement of the wide-angle cameras and their image pickup range;

FIG. 10 is a plan view of a vehicle equipped with the wide-angle cameras shown in FIG. 9 in which the vehicle is starting to enter the road in a forward-moving direction from a parking lot or a narrow road;

FIG. 11 is a plan view of a vehicle that is advancing even further onto the road than that shown in FIG. 10 in which the vehicle is starting to turn left;

FIG. 12(a) shows the image displayed on the display monitor provided on the image pickup device pertaining to the comparative example (Example 1);

FIG. 12(b) is a plan view of the entry conditions of a vehicle when it takes the image shown in FIG. 12(a) (Example 1);

FIG. 13(a) shows the image displayed on the display monitor provided on the image pickup device pertaining to the comparative example (Example 2);

FIG. 13(b) is a plan view of the entry conditions of a vehicle when it takes the image shown in FIG. 13(a) (Example 2);

FIG. 14 is a block diagram of the overall configuration of the image pickup device pertaining to Embodiment 4 of the present invention;

FIG. 15(a) is one example of the camera position and image pickup ranges for each camera installed on the vehicle, as shown in FIG. 14;

FIG. 15(b) is a graph explaining the basis for defining the image pickup range;

FIG. 16 is one example of the situation in which the image pickup device shown in FIG. 14 operates (Example 1). In this Figure, (a) is a road diagram showing the position of the vehicle and the road and (b) is a type diagram showing the base line and target range set by the image pickup device;

FIG. 17 is another example of the situation in which the image pickup device shown in FIG. 14 operates (Example 2). In this figure, (a) is a road diagram showing the position of the vehicle and the road and (b) is a type diagram showing the base line and target range set by the image pickup device;

FIG. 18 is another example of the situation in which the image pickup device shown in FIG. 14 operates (Example 3). In this figure, (a) is a road diagram showing the position of the vehicle and the road and (b) is a type diagram showing the base line and target range set by the image pickup device;

FIG. 19 is an explanation of the method used for prioritizing the cameras when the image pickup device in FIG. 14 selects the camera images, which corresponds to the situation shown in FIG. 18;

FIG. 20 is a type diagram showing the display screen for the display monitor shown in FIG. 14;

FIG. 21 is an explanation of the display policy; and

FIG. 22 is a flow chart showing the image pickup method employed by the image pickup device shown in FIG. 14.

### DETAILED DESCRIPTION

Below is provided an explanation of the embodiments for executing the present invention with reference to the Figures. All parts in the Figures that are the same or similar have been referenced using the same symbols.

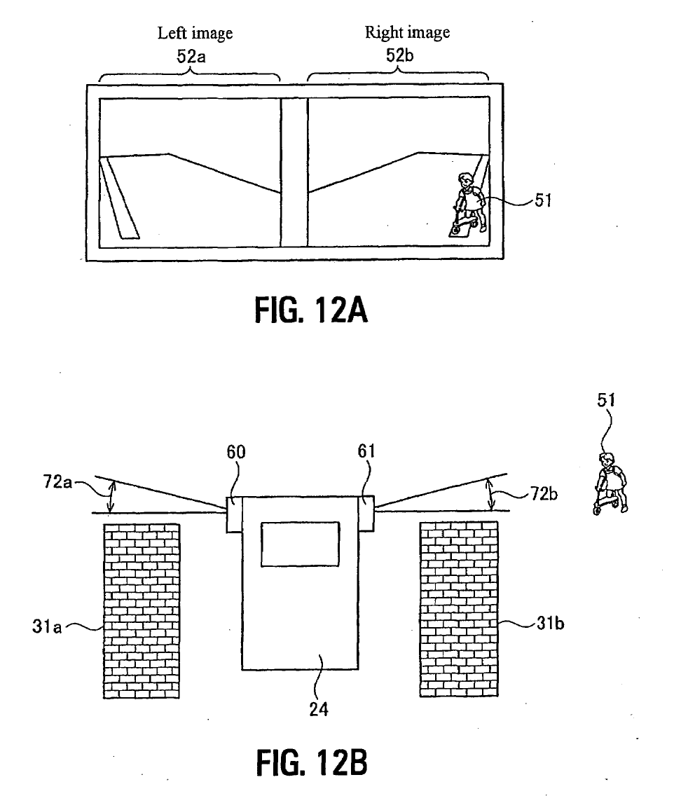

A device that has already been marketed is shown in FIG. 12(b), in which cameras 60 and 61 are arranged on either side of the front of vehicle 24 in order to observe blind spots 72a and 72b at intersections with poor visibility. This Figure illustrates an example of an intersection with poor visibility in which the vehicle enters a narrow road surrounded on both sides by high walls 31a and 31b from a wide road. As shown in FIG. 12(b), when the vehicle approaches from a wide road in a perpendicular direction, cameras 60 and 61 can observe the correct blind spots 72a and 72b. In other words, as shown in FIG. 12(a), person 51 that is in the correct blind spot 72b is projected in image 52b, which is indicated to the driver of the vehicle so that the driver can be aware of the person's presence.

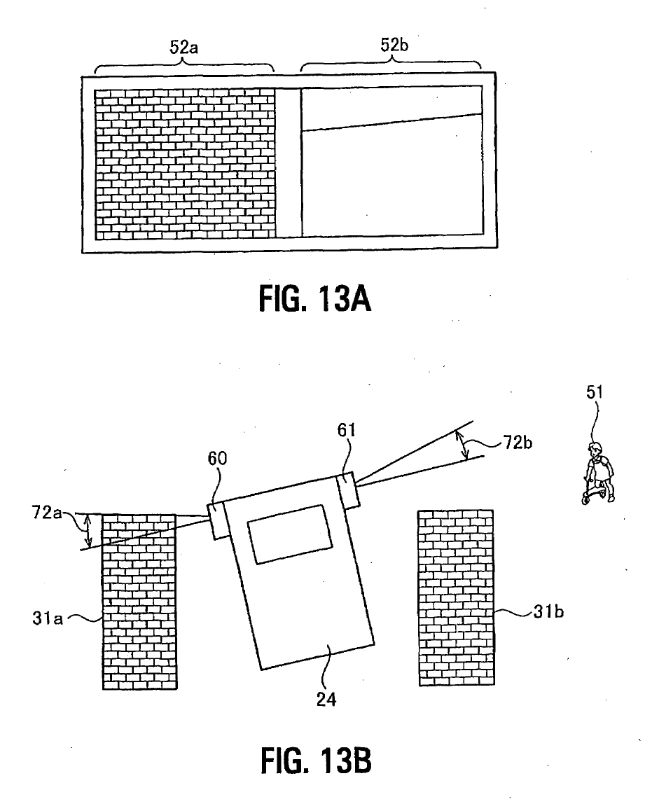

However, since range 72a and 72b, in which cameras 60 and 61 can pickup images is limited, if image pickup range 72a and 72b do not coincide with the correct blind spots, the driver cannot observe the blind spots via the images picked up by cameras 60 and 61. For example, as shown in FIG. 13(b), if a vehicle approaches from a wide road diagonally instead of perpendicularly, cameras 60 and 61 cannot observe correct blind spots 72a and 72b. As shown in FIG. 13(a), only wall 31a is projected in image 52a that is picked up by left camera 60 and the correct blind spot is not projected in image 52b that is picked up by right camera 61, so the driver is not aware of person 51 that is in the blind spot. Generally speaking, since there are various different types of entry conditions for a vehicle, entry conditions in which the necessary observations can be made are actually very limited.

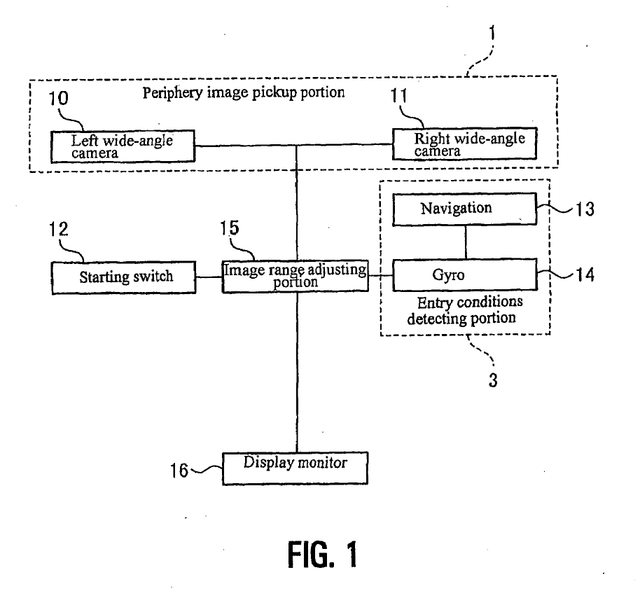

As shown in FIG. 1, the image pickup device pertaining to Embodiment 1 for executing the present invention provides periphery image pickup portion 1 comprised of a plurality of periphery image pickup means (a plurality of cameras) that obtain images of the periphery of a vehicle wherein the camera that obtains the image displayed to the driver of the vehicle and the image range of the image obtained by said camera and displayed to the driver of the vehicle are selected according to the conditions in which said vehicle enters a road that intersects the direction in which the vehicle is traveling.

More specifically, the image pickup device in FIG. 1 provides a plurality of cameras 10 and 11 for pickup images of the periphery of the vehicle, starting switch 12 as one example of a starting point detecting means that detects the starting point at which images picked up by said plurality of cameras 10 and 11 begin to get displayed to the driver of the vehicle, entry conditions detecting portion 3 as one example of an entry conditions detecting means that detects the conditions in which a vehicle enters the road at the display starting point detected by starting switch 12, image range adjusting portion 15 as one example of an image range adjustment means that adjusts the image range displayed in accordance with the entry conditions detected by entry conditions detecting portion 3 and display monitor 16 as one example of a display means that displays the image range that is adjusted by image range adjusting portion 15.

The term, “entry conditions”, as used herein, refers to the entry angle and position of the vehicle in relation to the extended direction (lengthwise) of the road that intersects with the direction in which the vehicle is traveling. Display monitor 16 appropriately displays the range of observation based on the conditions in which the vehicle enters the road. The plurality of cameras that constitute periphery image pickup portion 1 consist of side cameras (left wide-angle camera 10 and right wide-angle camera 11) arranged at either side of the vehicle. Left wide-angle camera 10 and right wide-angle camera 11 can each obtain images at a 180-degree wide-angle range. In addition, included in entry conditions detecting portion 3 are navigation 13 for obtaining information on the position of the vehicle and the surrounding roads and gyro 14 for obtaining absolute direction information for the vehicle.

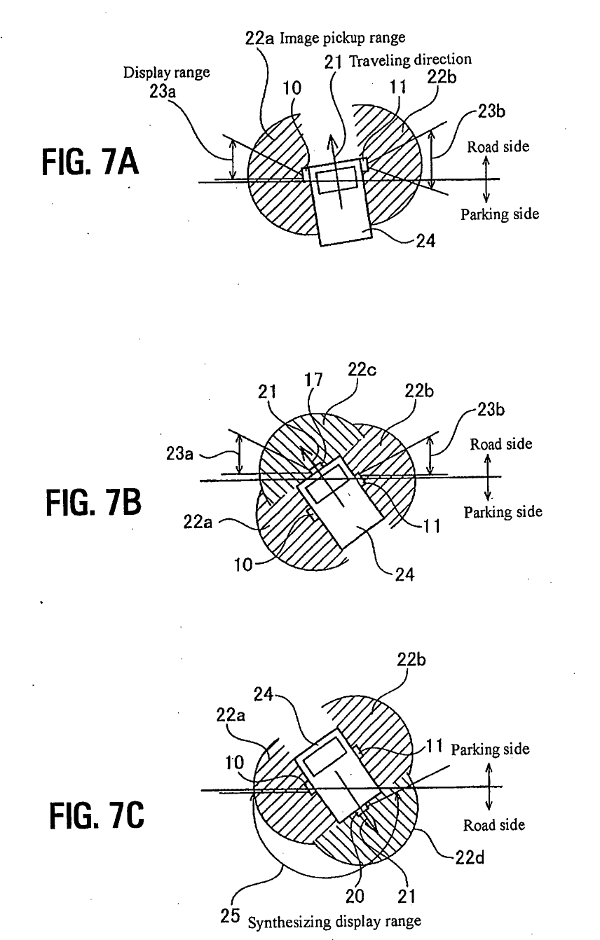

As shown in FIG. 8, left wide-angle camera 10 and right wide-angle camera 11 are each arranged at the front end of vehicle 24 to obtain 180-degree wide-angle range images 22a and 22b. In FIG. 7(a), is an illustration of the vehicle equipped with the image pickup device shown in FIG. 1 that is diagonally entering the side on which the road is located in a forward-moving direction from the side on which the vehicle is parked. In other words, traveling direction 21 indicates a diagonal entry condition and not a perpendicular direction in relation to the road. So, when the vehicle enters the road from a parking lot in a diagonal direction, image range adjusting portion 15 adjusts the portion that corresponds to the correct blind spot range from image pickup range 22a, 22b taken by left wide-angle camera 10 and right wide-angle camera 11 to create adjusted display range 23a and 23b, which are displayed on display monitor 16. In other words, the range of the picture angle for the side views can be adjusted separately for both right and left depending on the entry conditions.

In this manner, as shown in FIG. 7(a), for example, when entering the road from a parking lot or when entering the highway from a narrow road, the left and right images of the road at the point at which only the front end of the vehicle enters the road are projected onto display monitor 16 located inside the vehicle and the traffic situation on the road can be confirmed.

In addition, after the vehicle enters the road from a parking lot or a narrow road, or the like, and proceeds to make a left turn or when the angle of entry in relation to the road is already at an angle, as shown in FIG. 7(a), the picture angle range required to confirm the right and left road situation from the image range obtained by the wide-angle camera in accordance with the vehicle's entry conditions (the entry direction, angle and position of the vehicle in relation to the lengthwise direction of the road) can be extracted by means of image conversion in order to provide the appropriate image range.

Thus, even when the vehicle is turning as it enters the road or when the angle of entry is not at a right angle, the situation of the left and right sides of the road can be displayed onto display monitor 16. By displaying such an image, particularly while a vehicle is turning, the presence of other vehicles can be confirmed in situations such as when the driver of a vehicle fails to see the other vehicle when conducting a safety check of the road ahead or when another vehicle approaches at a speed that exceeds the legal speed limit, thus allowing for a safer entry onto the road.

At this point, the entry conditions (angle and position) for the vehicle entering the road can also be calculated from road information obtained by navigation 13 and information obtained by gyro 14.

In addition, it is also desirable to pre-set the optimum picture angle range in order to confirm the situation of the left and right sides of the road to determine the entry conditions for the vehicle entering the road. This will allow for an increasingly appropriate image range. Furthermore, if the picture angle range is stored in navigation 13 in accordance with the width of the road onto which the vehicle is entering, the maximum setting can be achieved for all types of roads.

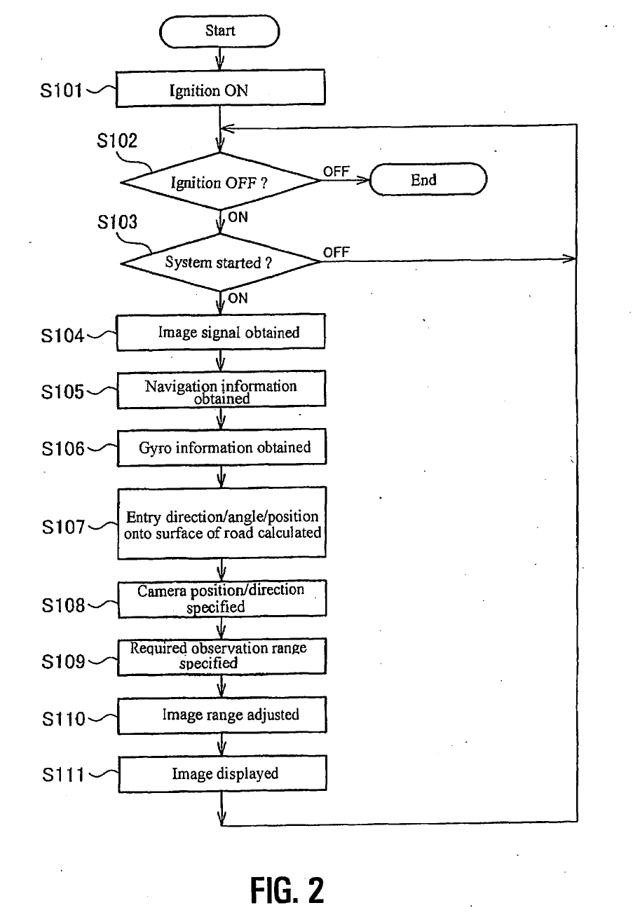

Next, an explanation is provided of the process for the image pickup device shown in FIG. 1 with reference to the flow chart in FIG. 2.

(a) First at Step S101, the ignition is turned ON at the discretion of the driver. At Step S102, the process determines whether the ignition has been turned OFF or not by the driver. If the ignition is ON (is ON at Step S102), the process proceeds to S103 and if the ignition is OFF (is OFF at Step S102), the flow process ends.

(b) Next, at Step S103, the process determines the start of the image pickup device shown in FIG. 1. If the image pickup device has been started (if it is ON at Step S103), the process moves to Step S104 and if the image pickup device has not been started (if it is OFF at Step S103), the process returns to Step S102.

(c) Next, at Step S104, image range adjusting portion 15 obtains the image signal forwarded from wide-angle cameras 10 and 11 and at Step S105, image range adjusting portion 15 obtains the current position of the vehicle and the map information of the vicinity from navigation 13. At Step S106, image range adjusting portion 15 obtains the absolute direction information of the vehicle from gyro 14.

(d) Next, at Step S107, the current position of the vehicle and the map information of the vicinity from navigation 13 and the absolute direction information of the vehicle from gyro 14 are used to calculate the direction of entry onto the road (forward or reverse direction/angle of entry (the angle in relation to the road)/entry position (the distance at which the vehicle advances onto the road). The entry position is defined as the distance from the base line of the road (for example, the line on the side at which the vehicle enters within the line that marks the width of the road) to the base line of the vehicle (for example the center of the rear wheel axle). At Step S108, the position (absolute position)/direction (absolute direction) of the camera installed on the vehicle is specified.

(e) Next, at Step S109, the range required for observation is specified in accordance with the entry conditions and at Step S110, image range adjusting portion 15 uses the image conversion to adjust the image range. Finally, at Step S111, display monitor 16 displays the adjusted image to the driver. After this, the process returns to S102, and Steps S102˜S111 are repeated to perform the process again.

It is desirable to execute Steps S102˜S111 while the vehicle is in the process of entering the road as well as after the vehicle has entered the road. In other words, even after the vehicle has entered the road, it is desirable to select cameras 10 and 11, which have obtained the images displayed to the driver of the vehicle and the image range of the images obtained by cameras 10 and 11 that is displayed to the driver of the vehicle in accordance with the conditions in which the vehicle enters the road.

As explained above, since the image pickup device pertaining to Embodiment 1 for executing the present invention is provided with entry conditions detecting portion 3 that detects the conditions in which a vehicle enters the road at the display starting point and image range adjusting portion 15 that adjusts the image range displayed in accordance with the conditions in which the vehicle enters the road, the optimum range of observation based on the conditions in which the vehicle enters the road can be appropriately displayed.

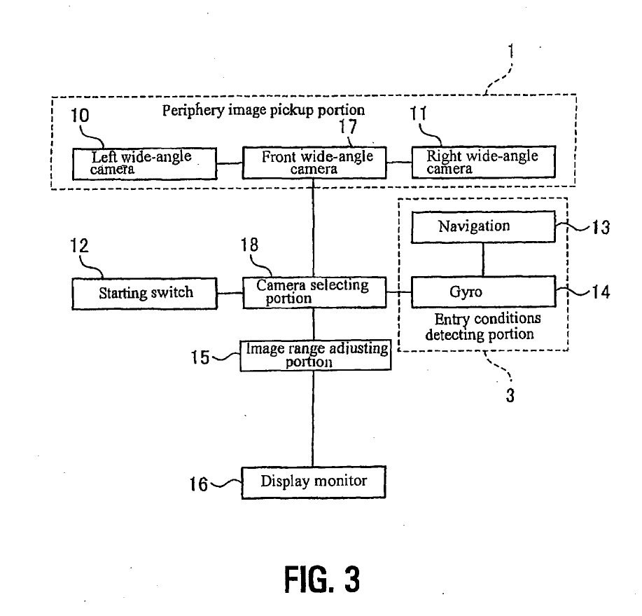

As shown in FIG. 3, the image pickup device pertaining to Embodiment 2 for executing the present invention is provided with periphery image pickup portion 1 consisting of a plurality of cameras that obtain images of the periphery of a vehicle, wherein the camera that obtained the images displayed to the driver of the vehicle and the image range of the images obtained by said camera that is displayed to the driver of the vehicle are selected in accordance with the conditions in which the vehicle enters the road.

More specifically, the image pickup device shown in FIG. 3 provides a plurality of cameras 10, 11, 17 that take images of the periphery of the vehicle, starting switch 12 that detects the starting point at which images picked up by said plurality of cameras 10, 11 and 17 begin to get displayed to the driver of the vehicle, entry conditions detecting portion 3 that detects the conditions in which a vehicle enters the road at the display starting point detected by starting switch 12, camera selecting portion 18 that appropriately selects cameras 10, 11 and 17 that obtain the images displayed to the driver of the vehicle based on the entry conditions detected by entry conditions detecting portion 3, image range adjusting portion 15 that adjusts the image range displayed based on the entry conditions detected by entry conditions detecting portion 3 and display monitor 16 that displays the image range that is adjusted by image range adjusting portion 15 from images taken by cameras 10, 11 and 17 as selected by camera selecting portion 18. The plurality of cameras that comprise periphery image pickup portion 1 include left wide-angle camera 10 and right wide-angle camera 11 that are arranged at either side of the front of the vehicle and front wide-angle camera 17 arranged on the front of the vehicle. Left wide-angle camera 10, right wide-angle camera 11 and front wide-angle camera 17 can each obtain images at a wide angle of approximately 180 degrees.

Thus, compared to the image pickup device in FIG. 1, the image pickup device shown in FIG. 3 differs in that it provides additional front wide-angle camera 17 and camera selecting portion 18, but the rest of the constitution is the same as that shown in FIG. 1, so further explanation is omitted.

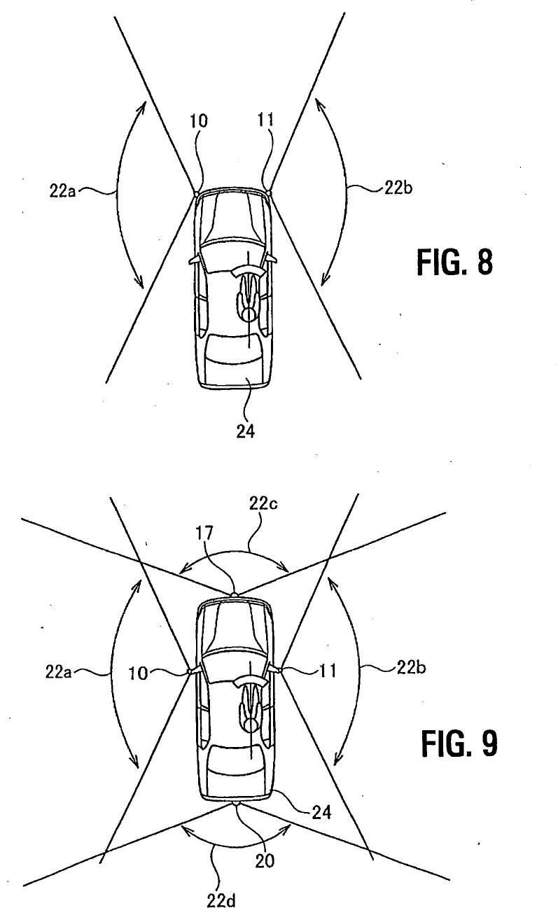

In recent years, image pickup of the periphery of a vehicle obtained by as few cameras as possible such as wide-angle cameras 10, 11, 17 and 20 installed at the front and side of vehicle 24, as shown in FIG. 9, have been considered. In such a case, wide-angle cameras 10 and 11, which take images from the side of the vehicle, are installed on the outermost part of the vehicle, or the side mirrors, instead of the front of the vehicle, as shown in FIG. 8, in order to efficiently take images of the periphery of vehicle 24. Left wide-angle camera 10 and right wide-angle camera 11 obtain images of 180-degree wide range areas 22a and 22b. In the same manner, front wide-angle camera 17 and rear wide-angle camera 20, which are arranged at the center front and center rear of vehicle 24, respectively, obtain images of 180-degree wide range areas 22c and 22d.

For FIG. 7(b), the vehicle provided with the image pickup device shown in FIG. 3 and that is disposed with the camera arrangement shown in FIG. 9, is shown diagonally entering the road from a parked position in the forward-moving direction. In other words, traveling direction 21 indicates a diagonal entry condition and not a perpendicular direction in relation to the road.

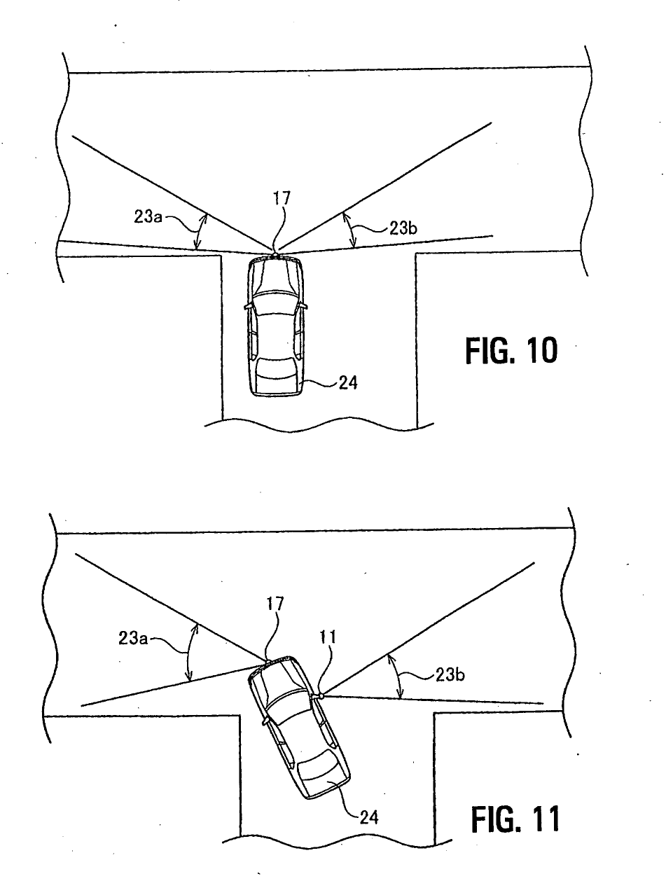

First, as shown in FIG. 10, when the vehicle starts to enter the road from a parking lot or a narrow road, or in other words, when only the front end of the vehicle enters the side on which the road is located, images of the left and right of the road taken by said front wide-angle camera 17 that is installed at the front end of vehicle 24 are cropped and displayed onto display monitor 16.

Then, as shown in FIG. 11, when vehicle 24 enters the road and attempts to turn left, front wide-angle camera 17 crops only range 23a, which corresponds to the appropriate blind spot for confirming the left side from the images taken, and then switches over to the images for the image range on the right side taken by right wide-angle camera 11 installed at the right side, crops optimum image range 23b from right wide-angle camera 11 and displays it onto display monitor 16.

In this manner, when the vehicle enters the road in the forward-moving direction, first, the image taken by front wide-angle camera 17 is displayed and when an image of one side of the road cannot be picked up by front wide-angle camera 17, the images taken by side cameras 10 and 11 are displayed. As the vehicle proceeds further onto the road, the image range of the right side that could not be obtained by front wide-angle camera 17 can be displayed via camera 11, which is installed on the right side, so the system can switch to the optimum camera for displaying the image of the picture angle range of the side view, depending on the entry conditions. However, it is necessary to choose the camera that covers the necessary picture angle range based on the entry conditions of vehicle 24.

When the angle of entry in relation to the road is at an angle to begin with, images of the left and right directions of the road can be displayed by properly selecting the range to be photographed and the camera in accordance with the angle of the vehicle at the point of entry. The correct and optimum display can be performed by pre-storing the relation between the image range obtained and the camera that is selected when switching the image range in relation to the road situation calculated by navigation 13 and gyro 14, as was done in Embodiment 1.

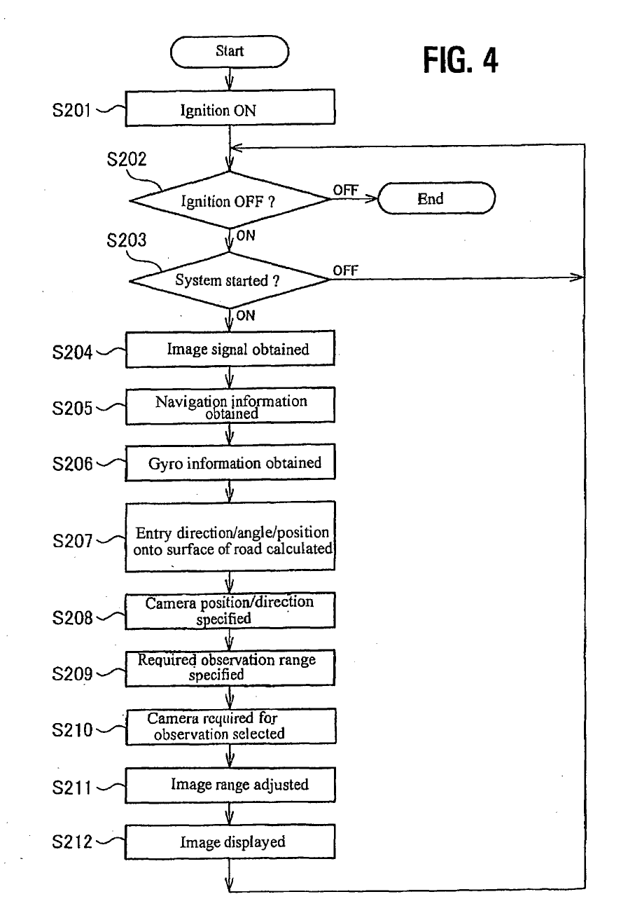

Next is provided an explanation of the process for the image pickup device shown in FIG. 3, with reference to the flow chart shown in FIG. 4.

(a) First at Step S201, the ignition is turned ON at the discretion of the driver. At Step S202, the process determines whether the ignition has been turned OFF or not by the driver. If the ignition is ON (is ON at Step S202), the process proceeds to S203 and if the ignition is OFF (is OFF at Step S202), the flow process ends.

(b) Next, at Step S203, the process determines the start of the image pickup device shown in FIG. 3. If the image pickup device has been started (if it is ON at Step S203), the process moves to Step S204 and if the image pickup device has not been started (if it is OFF at Step S203), the process returns to Step S202.

(c) Next, at Step S204, camera selecting portion 18 obtains the image signal forwarded from wide-angle cameras 10, 11 and 17 and at Step S205, camera selecting portion 18 obtains the current position of the vehicle and the map information of the vicinity from navigation 13. At Step S206, camera selecting portion 18 obtains the absolute direction information of the vehicle from gyro 14.

(d) Next, at Step S207, the current position of the vehicle and the map information of the vicinity from navigation 13 and the absolute direction information of the vehicle from gyro 14 are used to calculate the direction of entry onto the road (forward or reverse direction/angle of entry (the angle in relation to the road)/entry position (the distance at which the vehicle advances onto the road). At Step S208, the position (absolute position)/direction (absolute direction) of the camera installed on the vehicle is specified.

(e) Next, at Step S209, the range required for observation is specified in accordance with the entry conditions and at Step S210, camera selecting portion 18 selects camera 10, 11 or 17 that picks up the image range required for observation in accordance with the entry conditions. At Step S211 image range adjusting portion 15 adjusts the image range required for observation from the images taken by the selected camera 10, 11 and 17. Finally, at Step S212, display monitor 16 displays the adjusted image to the driver. After this, the process returns to S202 and Steps S202˜S212 are repeated to perform the process again.

It is desirable to execute Steps S202˜S212 while the vehicle is in the process of entering the road as well as after the vehicle has entered the road. In other words, even after the vehicle has entered the road, it is desirable to select cameras 10, 11 or 17 which have obtained the images displayed to the driver of the vehicle and the image range of the images obtained by cameras 10, 11 or 17 that is displayed to the driver of the vehicle.

As explained above, since the image pickup device pertaining to Embodiment 2 is provided with entry conditions detecting portion 3 that detects the conditions in which a vehicle enters the road at the display starting point that is displayed to the driver and image range adjusting portion 15 that adjusts the image range displayed in accordance with the conditions in which the vehicle enters the road, the optimum range of observation based on the conditions in which the vehicle enters the road can be appropriately displayed.

In addition, since the image pickup device pertaining to Embodiment 2 is provided with camera selecting portion 18 for appropriately selecting camera 10, 11 or 17 based on the conditions in which the vehicle enters the road, it can appropriately display the optimum range of observation for any type of entry conditions.

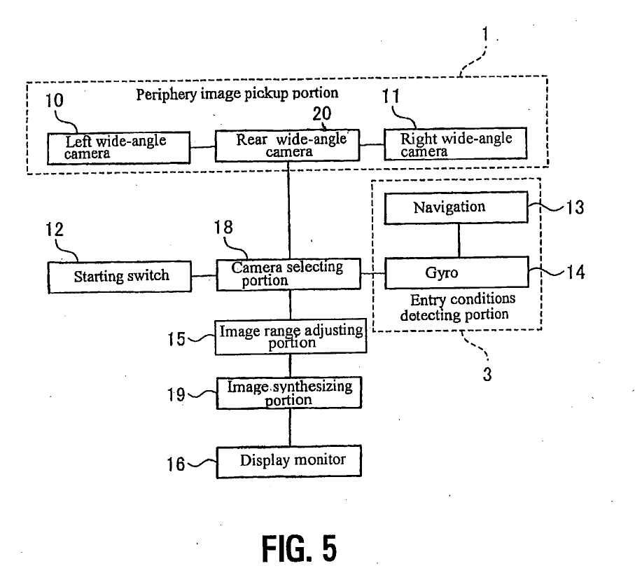

As shown in FIG. 5, the image pickup device pertaining to Embodiment 3 of the present invention provides periphery image pickup portion 1 comprised of a plurality of cameras that obtain images of the periphery of a vehicle and the camera that obtains the images displayed to the driver of the vehicle and the image range of the images obtained by said camera that is displayed to the driver of the vehicle are selected in accordance with the conditions in which the vehicle enters the road.

More specifically, the image pickup device shown in FIG. 5 provides a plurality of cameras 10, 11 and 20 that take images of the periphery of a vehicle, starting switch 12 that detects the starting point at which images picked up by said plurality of cameras 10, 11 and 20 begin to get displayed to the driver of the vehicle, entry conditions detecting portion 3 that detects the conditions in which a vehicle enters the road at the display starting point detected by starting switch 12, camera selecting portion 18 that appropriately selects cameras 10, 11 and 20 that obtain the images displayed to the driver of the vehicle based on the entry conditions detected by entry conditions detecting portion 3, image range adjusting portion 15 that adjusts the image range displayed based on the entry conditions detected by entry conditions detecting portion 3, image synthesizing portion 19 that synthesizes the images taken by the plurality of cameras, and display monitor 16 that displays the synthesized image range that is adjusted by image range adjusting portion 15 from images taken by cameras 10, 11 and 20 as selected by camera selecting portion 18. The plurality of cameras that comprise periphery image pickup portion 1 include left wide-angle camera 10 and right wide-angle camera 11 that are arranged at either side of vehicle 24 and rear wide-angle camera 20 arranged at the rear of the vehicle 24. Left wide-angle camera 10, right wide-angle camera 11 and rear wide-angle camera 20 can each obtain images at a wide angle of approximately 180 degrees. When a plurality of images taken by the plurality of cameras 10, 11 and 20 include an overlapping portion in the image range adjusted by image range adjusting portion 15, image synthesizing portion 19 synthesizes said plurality of images. In other words, when the image range adjusted by image range adjusting portion 15 extends into plurality of cameras 10, 11 and 20, image synthesizing portion 19 synthesizes the images.

Thus, compared to the image pickup device in FIG. 1, the image pickup device shown in FIG. 5 differs in that it provides additional rear wide-angle camera 20, camera selecting portion 18 and image synthesizing portion 19, but the rest of the constitution is the same as that shown in FIG. 1, so further explanation is omitted.

FIG. 7(c) shows a vehicle equipped with the image pickup device shown in FIG. 5 and that has the camera arrangement shown in FIG. 9 and is an illustration of a diagonal entry onto the road in the reverse direction from the side on which the parking lot is located to the side on which the road is located. In other words, traveling direction 21 indicates a diagonal entry condition and not a perpendicular direction in relation to the road.

First, when the vehicle starts to enter the road from a parking lot or a narrow road, or in other words, when only the front end of the vehicle enters the side on which the road is located, an image of the left and right of the road taken by rear wide-angle camera 20 that is installed at the rear of vehicle 24 is cropped and displayed onto display monitor 16.

Then, as shown in FIG. 7(c), as vehicle 24 proceeds even further onto the road, image range 22d taken by rear wide-angle camera 20 and left side image range 22a taken by left wide-angle camera 10 overlap. When the camera that covers the necessary picture angle range based on the entry conditions of the vehicle is rear wide-angle camera 20 and left wide-angle camera 10, image ranges 22d and 22a taken by rear wide-angle camera 20 and left wide-angle camera 10 are synthesized and displayed on display monitor 16. In other words, when vehicle 24 enters the road in the reverse direction, the image taken by left wide-angle camera 10 and the image taken by rear wide-angle camera 20 are synthesized and displayed.

In this manner, as shown in FIG. 7(c) for example, when entering the road slowly in the reverse direction or when entering a parking lot from the road in the reverse direction or the like, the image ranges from the camera on the side of the vehicle and the camera on the rear of the vehicle are appropriately changed in accordance with the conditions in which the vehicle enters the road, are synthesized into an image with a 180 degree range of the rear of the vehicle and displayed. By synthesizing an image of the road into a 180-degree range and displaying it, the driver can easily confirm obstacles on the road to the rear periphery of the vehicle. It also becomes easier to confirm obstacles on a sidewalk when entering the road from the sidewalk.

When the angle of entry in relation to the road is at an angle to begin with, the image of the rear periphery of the vehicle can be displayed by appropriately selecting the range to be taken and the camera based on the angle of the vehicle at the point of entry. By switching the image range and the camera that obtains the images, the correct and optimum display can be performed by pre-storing the relation between the image range obtained and the camera that is selected when switching in relation to the road situation calculated by navigation 13 and gyro 14, as was done in Embodiment 1.

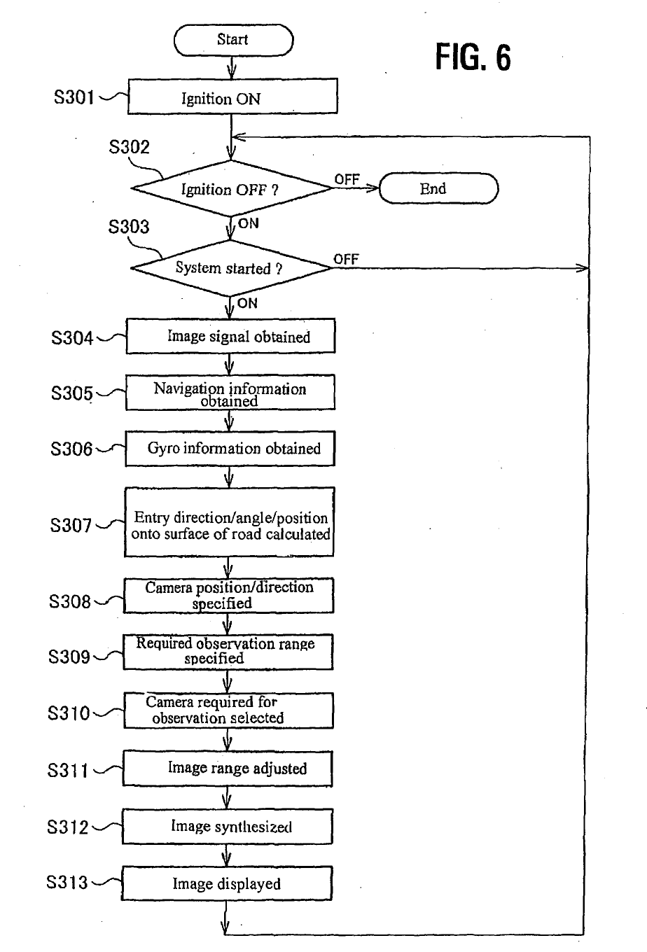

Next, an explanation is provided of the process for the image pickup device shown in FIG. 5 with reference to the flow chart in FIG. 6.

(a) First at Step S301, the ignition is turned ON at the discretion of the driver. At Step S302, the process determines whether the ignition has been turned OFF or not by the driver. If the ignition is ON (is ON at Step S302), the process proceeds to S303 and if the ignition is OFF (is OFF at Step S302), the flow process ends.

(b) Next, at Step S303, the process determines the start of the image pickup device shown in FIG. 5. If the image pickup device has been started (if it is ON at Step S303), the process moves to Step S304 and if the image pickup device has not been started (if it is OFF at Step S303), the process returns to Step S302.

(c) Next, at Step S304, camera selecting portion 18 obtains the image signal forwarded from wide-angle cameras 10, 11 and 20 and at Step S305, camera selecting portion 18 obtains the current position of the vehicle and the map information of the vicinity from navigation 13. At Step S306, camera selecting portion 18 obtains the absolute direction information of the vehicle from gyro 14.

(d) Next, at Step S307, the current position of the vehicle and the map information of the vicinity from navigation 13 and the absolute direction information of the vehicle from gyro 14 are used to calculate the direction of entry onto the road (forward or backward direction/angle of entry (the angle in relation to the road)/entry position (the distance at which the vehicle advances onto the road). At Step S308, the position (absolute position)/direction (absolute direction) of the camera installed on the vehicle is specified.

(e) Next, at Step S309, the range required for observation is specified in accordance with the entry conditions and at Step S310, camera selecting portion 18 selects camera 10, 11 or 20 that takes the required observation range based on the entry conditions. At Step S311, image range adjusting portion 15 adjusts the images taken by selected cameras 10, 11 and 20 to the image range required for observation. At Step S312, image synthesizing portion 19 synthesizes the plurality of images taken by camera 10, 11 and 20. Finally, at Step S313, display monitor 16 displays the synthesized image to the driver. After this, the process returns to S302 and Steps S302˜S313 are repeated to perform the process again.

It is desirable to execute Steps S302˜S313 while the vehicle is in the process of entering the road as well as after the vehicle has entered the road. In other words, even after the vehicle has entered the road, it is desirable to select cameras 10, 11 and 20, which have obtained the images displayed to the driver of the vehicle and the image range of the images obtained by cameras 10, 11 and 20 that is displayed to the driver of the vehicle and synthesize these plurality of images.

As explained above, since the image pickup device pertaining to Embodiment 3 for executing the present invention is provided with entry conditions detecting portion 3 that detects the conditions in which a vehicle enters the road at the point at which images start getting displayed to the driver and image range adjusting portion 15 that adjusts the image range displayed in accordance with the conditions in which the vehicle enters the road, the optimum range of observation based on the conditions in which the vehicle enters the road can be appropriately displayed.

In addition, since the image pickup device pertaining to Embodiment 3 is provided with camera selecting portion 18 for appropriately selecting camera 10, 11 and 20 based on the conditions in which the vehicle enters the road, it can appropriately display the optimum range of observation for any type of entry conditions.

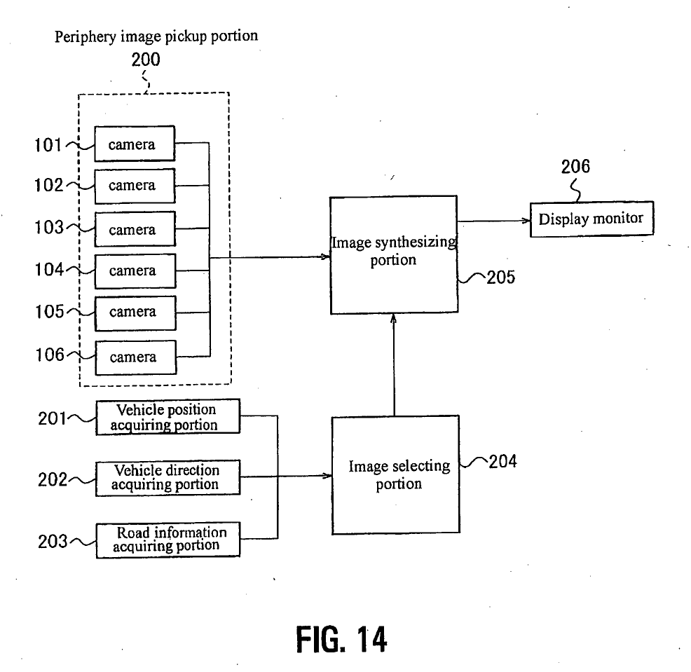

As shown in FIG. 14, the image pickup device pertaining to Embodiment 4 is provided with a plurality of periphery image pickups portion 200 (periphery image pickup means) for obtaining image of the periphery of a vehicle wherein periphery image pickups portion 200 for obtaining images to be displayed to the driver of the vehicle and the image range of the images obtained by periphery image pickups portion 200 that are displayed to the driver of the vehicle are selected and synthesized.

More specifically, it is provided with plurality of periphery image pickups portion 200 consisting of plurality of cameras 101˜106 for taking images of the periphery of a vehicle, vehicle position acquiring portion 201 (vehicle position acquiring means) for acquiring the global position of a vehicle, vehicle direction acquiring portion 202 (vehicle direction acquiring means) for acquiring the global direction of a vehicle, road information acquiring portion 203 (road information acquiring means) for acquiring road information for the periphery of a vehicle, image selecting portion 204 (image selecting means) for selecting the images from cameras 101˜106 to be used, based on the position of each camera on the vehicle, the vehicle position, the vehicle direction and road information and display monitor 206 (display means) for displaying the selected image or a plurality of images to the driver of the vehicle.

Vehicle position acquiring portion 201 acquires the global position of the vehicle. Vehicle direction acquiring portion 202 acquires the global direction of the vehicle. Road information acquiring portion 203 acquires road information for the periphery of the vehicle. Since devices 201 through 203 are provided to function as the navigation system, this information can be acquired from a navigation system.

The information for the global position of the vehicle, the global direction of the vehicle and the road information acquired by devices 201˜203 is sent to image selecting portion 204. Inside of image selecting portion 204 is stored information on the image pickup range and the direction and position of cameras 101˜106 installed on the vehicle. The speed of the vehicle can be calculated from the global position information and the global direction information of the vehicle, or can, of course, be obtained directly from the vehicle.

Image synthesizing portion 205 selects the images from the camera[s] to be used based on a list of cameras 101˜106 selected by image selecting portion 204 and synthesizes the pictures arranged on the display screen. Commonly known technology pertaining to the field of image processing can be used for the actual picture synthesizing operation.

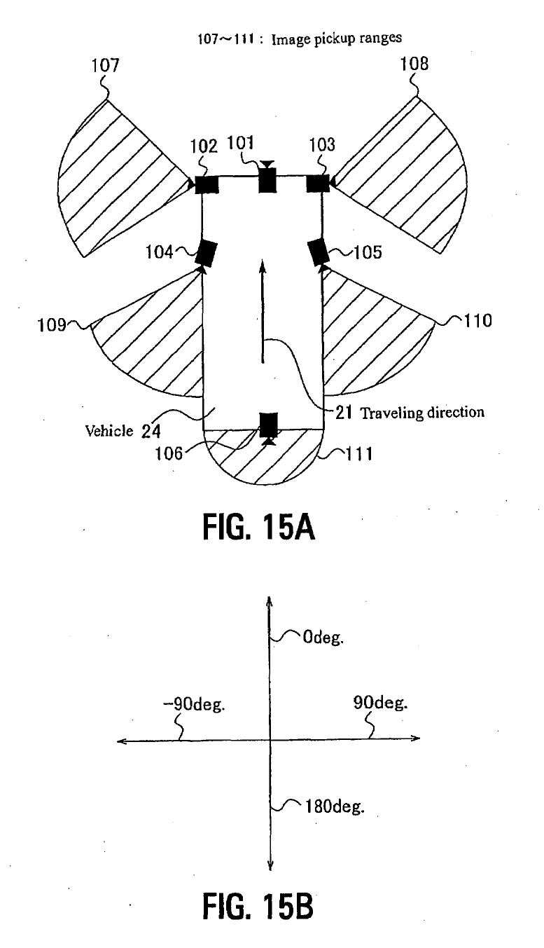

Cameras 101˜106 in FIG. 14 are installed in the position on vehicle 24, as shown in FIG. 15(a), for example. Each of cameras 102˜106 can take pictures of image pickup ranges 107˜111, respectively. Here, the direction of the vehicle (traveling direction 21) is set in the direction shown in FIG. 15(b). Vehicle direction 21 is set at 0 degrees, the rear direction at 180 degrees, the right direction at 90 degrees and the left direction at −90 degrees. This direction information is used to express image pickup ranges 107˜111. Specifically, 0 degrees, 180 degrees, 90 degrees and −90 degrees are the base angles and each of image pickup ranges 107˜111 is defined as the starting angle: passage angle: ending angle. The passage angle is any one of the base angles. Therefore, image pickup range 107 is expressed as −30:−90:−120, image pickup range 108 is expressed as 30:90:120, image pickup range 109 is expressed as −120:180:180, image pickup range 110 is expressed as 120:180:180 and image pickup range 111 is expressed as −90:180:90.

The starting angle is set at the side of traveling direction 21 (front side), for example. For this setting, if the starting angle is in the same position as the front side of the vehicle (image range 111, for example), the starting position is set as the left side in relation to traveling direction 21 of the vehicle.

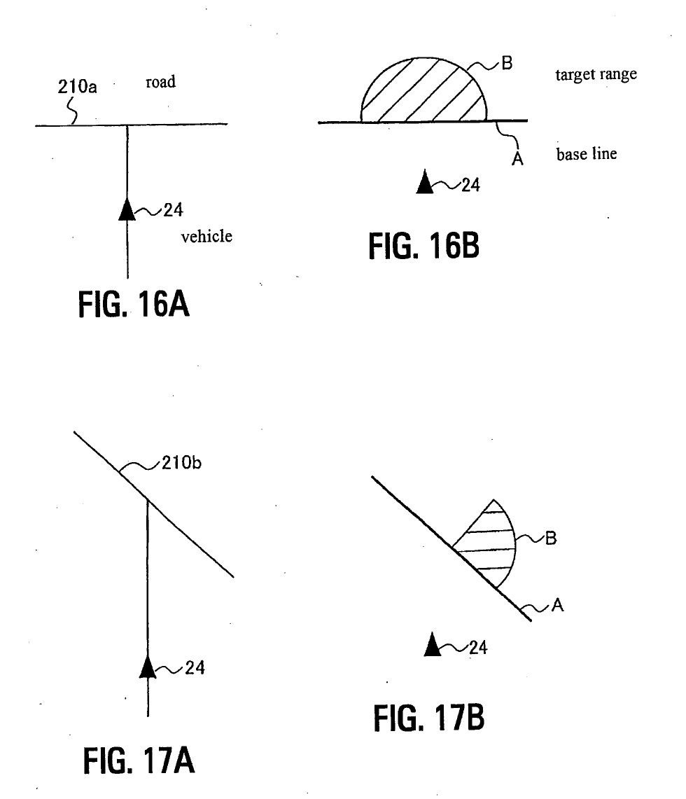

FIGS. 16˜18 are explanatory diagrams of various situations in which the image pickup device shown in FIG. 14 operates. Element (a) in each Figure is a road diagram showing the position of vehicle 24 and road 210 and (b) is a type diagram showing base line A and target range B set by the image pickup device. The direction in which the acute angle of the isosceles triangle indicated as vehicle 24 is pointed is the traveling direction of vehicle 24.

Image pickup portion 204 in FIG. 14 corrects the relationship between vehicle 24 and road 210 that intersects with the traveling distance of vehicle 24 to base line A and target range B of vehicle 24, as shown in FIG. 16(b), for example, based on the road information, the global position and global direction of vehicle 24 and the vehicle speed.

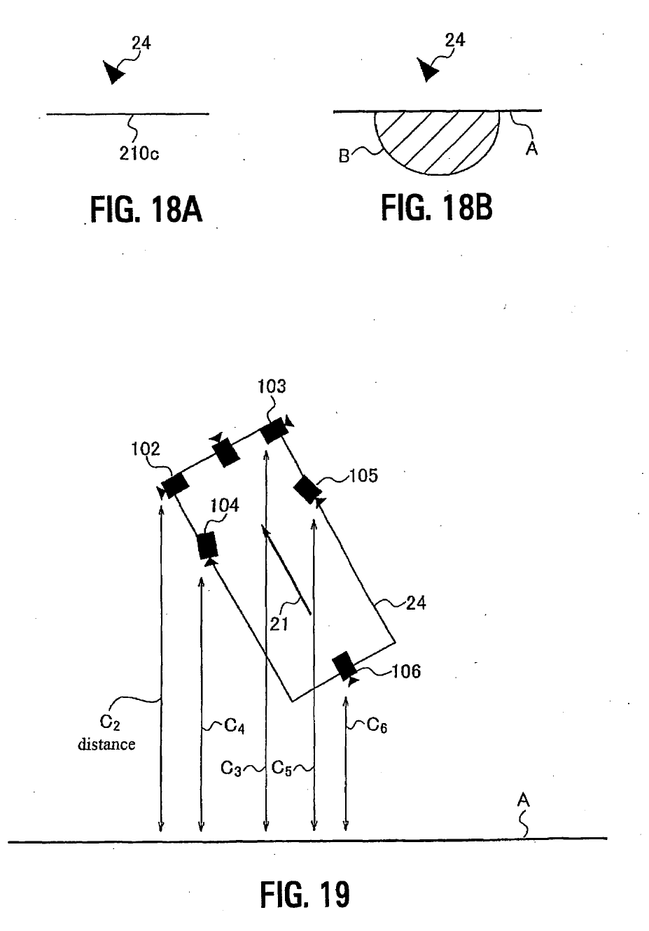

FIGS. 16 and 17 are examples of vehicle 24 moving in the forward direction and merging with another road 210a and 210b and FIG. 18 is an example of vehicle 24 moving in the reverse direction and merging with another road 210c. In either case, for FIGS. 16˜18, the vehicle draws base line A as it approaches road 210 onto which it is about to merge.

Next, the range that the driver wants to view is set as target range B. Target range B can simply be set as a 180-degree angle at the side on which vehicle 24 is not located in relation to base line A, as shown in FIGS. 16(b) and 18(b), for example. Or, the setting can be changed in accordance with the situation of the road that the vehicle is about to merge with. For example, for the situation shown in FIG. 17(a), since right turns are prohibited for road 210b, onto which the vehicle is about to merge, so when vehicle 24 knows that it can only proceed in the left direction based on road information from road information acquiring portion 203, target range B is set on the right side of road 210b onto which the vehicle is about to merge, as shown in FIG. 17(b).

As was the case with image pickup ranges 107˜111 for each camera, as shown in FIG. 15(a), target range B also has vehicle direction (traveling direction) 21 as its base and is defined according to three angles (starting angle: passage angle: ending angle). So, for example, for the situation in FIG. 16, target range B is defined as −90:0:90 and as 45:90:120 for the situation shown in FIG. 17 and −60:180:120 for the situation shown in FIG. 18.

Thus, image selecting portion 204, shown in FIG. 14, selects images from cameras 101˜106 based on target range B, which is determined from the relationship between vehicle 24 and road 210, and image pickup ranges 107˜111 from each of cameras 101˜106 on vehicle 24.

Next is provided an explanation of the method used to prioritize cameras 101˜106 when image selecting portion 204, shown in FIG. 14, selects images from cameras 101˜106, with reference to FIG. 19. FIG. 19 corresponds to the situation shown in FIG. 18.

(a) For each situation in FIGS. 16˜18, image selecting portion 204 obtains the straight-line distances, C₂˜C₆, from each of cameras 102˜106 on vehicle 24 to the road (base line A) and prioritizes each of cameras 102˜106. Straight-line distances C₂˜C₆ are prioritized so that the camera at the shortest distance has the highest priority. For example, if straight-line distances C₂˜C₆ to base line A are considered to be those shown in FIG. 19, then the priority of cameras 102˜106, in the order of highest priority, would be 106, 104, 105, 102 and 103. When the positions of each of cameras 102˜106 move beyond base line A to the side on which target range B has been set, or in other words, when a camera enters road 210, the priority of that camera should be set so that it is higher than that of the cameras that have not moved beyond base line A.

(b) Next, image selecting portion 204 uses image pickup ranges 107˜111 from each of cameras 102˜106 and the priority of each of cameras 102˜106 to decide which camera to use. Specifically, as explained above, target range B in FIG. 18(b) is −60:180:120. The cameras are considered in order of highest priority to decide which camera to use. For example, the camera with the highest priority is camera 106. Image pickup range 111 of camera 106 is −90:180:90. Since there is an overlapping range (−90:180:120) when target range B, shown in FIG. 18(b), and image pickup range 111 of camera 106 are compared, camera 106 is selected as the camera to be used.

(c) Next, overlapping range (−90:180:120) is excluded from target range B (−60:180:120). And as a result, the remaining range of target range B is −60:−90:−90. If there is no overlapping range between target range B and the image pickup range of the camera with the highest priority, the camera with the highest priority is not selected so there is no range to be excluded. In the example shown in FIG. 19, since there is a remaining range for target range B, the same process is performed for the camera with the second highest priority, or camera 104. Image pickup range 109 of camera 104 is −120:180:180. And since there is no overlapping range compared to the remaining range of target range B (−60:−90:−90), camera 104 is not selected as the camera to be used.

(d) The same process is then performed for camera 105, which has the third highest priority, since there is still a remaining range in target range B. However, since image pickup range 110 of camera 105 also has no overlapping range with the remaining range (−60:−90:−90) of target range B, it is not selected as the camera to be used. Then, when the same process is performed for camera 102, which has the fourth highest priority, since there is a portion that overlaps with the remaining range of target range B, image selecting portion 204 selects camera 102 as the camera to be used. Then, when the range that overlaps with image pickup range 107 of camera 102 is excluded from the remaining portion of target range B, the remaining portion disappears. At the point at which the remainder of target range B disappears, the cameras with lower priorities are not used. In this example, it is decided not to use camera 103 without making any comparisons. According to the aforementioned process, cameras 106 and 102 are selected as the cameras to be used. Image selecting portion 204 sends a list of the cameras selected according to the aforementioned process to image synthesizing portion 205.

In this manner, image selecting portion 204 selects images from cameras 101˜106 based on straight-line distances C₂˜C₆, target range B and image pickup ranges 107˜111 from each of the cameras on vehicle 24. It can then be decided which camera to use from cameras 101˜106 by conducting a simple comparison and a faster, less expensive image pickup device can be provided.

Cameras 102 and 103 are selected as the cameras to be used in the same manner for the situation shown in FIG. 16. In this case, when the aforementioned process is performed for all of the cameras, there will be a range remaining in image range B shown in FIG. 16, but this range can be designated as a range in which image pickup cannot be performed.

In addition, camera 103 is selected as the camera to be used in the same manner for the situation in FIG. 17. Although three or more cameras can be simultaneously selected depending on the arrangement of the cameras and the image pickup range, it is not desirable for the driver to view a display in which too many images are displayed at once, so selection can be restricted to the first two cameras that are selected for use.

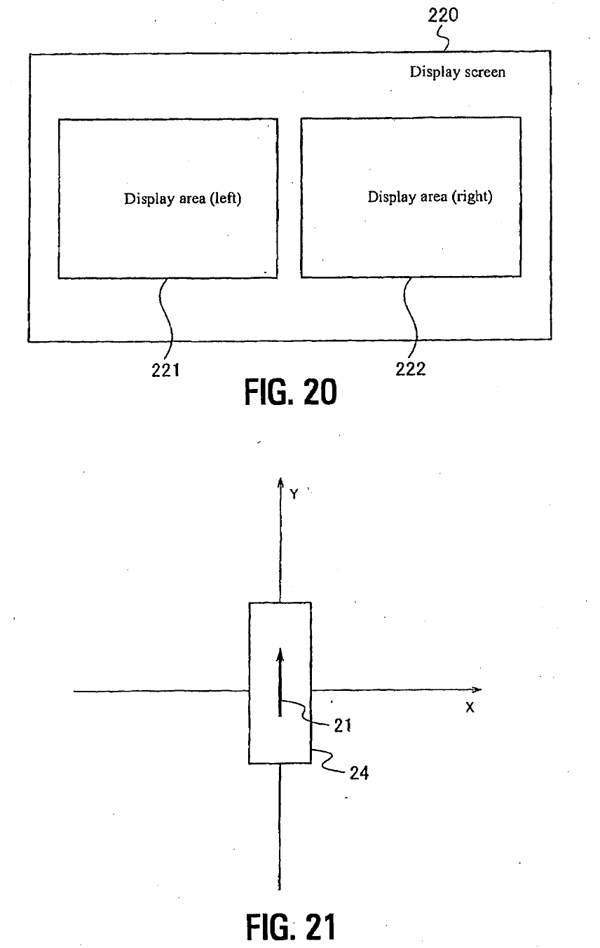

As shown in FIG. 20, display monitor 206 shown in FIG. 14 is equipped with display screen 220 that consists of two independent display areas, (left) display area 221 and (right) display area 222 and can simultaneously display images from two cameras selected by image selecting portion 204. When display monitor 206 displays the images selected by image selecting portion 204, it determines the positional relationship for the display with consideration made to the positional relationship of the original camera.

Image synthesizing portion 205 selects the image from the camera being used based on the list of cameras being used sent from image selecting portion 204 and synthesizes the pictures arranged on display screen 220 of display monitor 206. Commonly known technology pertaining to the field of image processing can be used for the actual picture synthesizing operation. When this takes place, the positional relationship of the mutual images reflects the physical positional relationship of the original camera. Specifically speaking, the position is first determined according to the positional relationship shown in the “X” direction in FIG. 21. At this point, the left/right relationship is not changed. Then when the positions in the “X” direction are the same, the image from the camera for which the “Y” direction is the minus direction is placed outside of display monitor 206.

If the situation shown in FIG. 18 is used as an example, the image from camera 102 is displayed in display area (left) 221 shown in FIG. 20. If the situation shown in FIG. 17 is used as an example, the image from camera 103 is displayed in display area (left) 221 and the image from camera 105 is displayed in display area (right) 222. If the situation shown in FIG. 16 is used as an example, the image from camera 102 is displayed in display area (left) 221 and the image from camera 103 is displayed in display area (right) 222.

The synthesized image created according to the aforementioned process is sent to display monitor 206 and displayed to the driver.

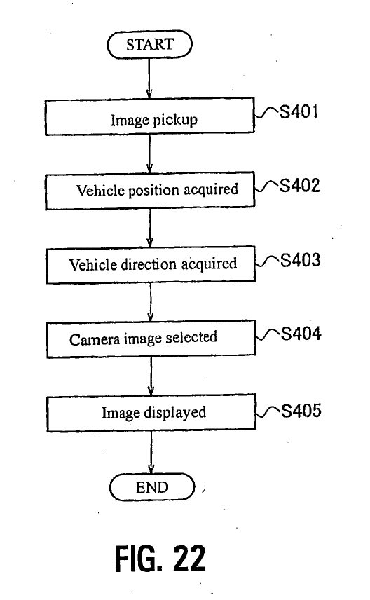

Next is provided an explanation of the image pickup method employed by the image pickup device shown in FIG. 14, with reference to FIG. 22.

(a) First, at Step S401, images of the periphery of vehicle 24 are taken by plurality of cameras 101˜106.

(b) Then, the process proceeds to Step S402 and vehicle position acquiring portion 201 acquires the global position of vehicle 24. Next, the process proceeds to Step S403 and vehicle direction acquiring portion 202 acquires the global direction of the vehicle.

(c) Next, road information for the vicinity of vehicle 24 is acquired by road information acquiring portion 203. The process proceeds to Step S404 and image selecting portion 204 selects the images from camera 106, which is the camera to be used, from the positions of each of cameras 101˜106 on vehicle 24, the global position, the global direction and the road information.

(d) The process then proceeds to Step S405 and the image or plurality of images selected is displayed to the driver of vehicle 24 using display monitor 206. Thus, according to the aforementioned process, the image pickup device shown in FIG. 14 can select the camera image to display and display it to the driver based on the circumstances of the periphery of vehicle 24.

The following effects can be achieved by Embodiment 4 for the present invention, as explained above.

Image selecting portion 204 selects images from cameras 101˜106 that are being used based on road information acquired by road information acquiring portion 203 and vehicle information (global position and global direction) acquired by vehicle position acquiring portion 201 and vehicle direction acquiring portion 202 so that only the range needed by the driver can be displayed on display monitor 206 in order to make it easier for the driver to view images.

Image selecting portion 204 selects images from cameras 101˜106 that are being used based on straight-line distances C₂˜C₆ between each of cameras 101˜106 on vehicle 24 and road 210, image range B that is determined from the relationship between vehicle 24 and road 210, and image pickup ranges 107˜111 of cameras 101˜106 on vehicle 24 so that selection of cameras 101˜106 that are being used can be performed by means of a simple comparison in order to provide a faster, less expensive image pickup device.

The priority for each of cameras 102˜106 is set so that the camera with the shortest distance for straight-line distances C₂˜C₆ between each of cameras 102˜106 on vehicle 24 and road 210 has the highest priority in order to realize this function by means of a simpler algorithm and provide a faster, less expensive image pickup device.

Target range B and pickup image ranges 107˜111 are represented only as angles so that the comparison can be carried out by means of a simpler algorithm in order to provide a faster, less expensive image pickup device.

When display monitor 206 displays the images selected by image selecting portion 204, it determines the positional relationship for the display with consideration made to the positional relationship of original cameras 101˜106 to allow for an easier-to-view display and improve the viewing for the driver.

Conventionally, for the device in which multiple cameras 101˜106 installed on vehicle 24 display images to the driver, a switch would have to be operated by the driver to switch the camera images so that multiple images could be displayed at once. However, such a device had problems because the switching operation was troublesome and unwanted images would get displayed. However, according to Embodiment 4, a device is provided that can automatically select the images from the relationship between vehicle 24 and road 210 and display them to the driver.

As explained above, the present invention has been described according to Embodiments 1 though 4 but it should not be interpreted that constitution of a portion of the disclosure or that the Figures limit the present invention. Based on the present disclosure, it is obvious to a person skilled in the art that there are various other embodiments that could be substituted to enforce the present invention as well as other working examples and operating technologies. In other words, it should be interpreted that the present invention encompasses various different types of embodiments that have not been described herein. Therefore, based on the present disclosure, the present invention is only limited to specific items of the invention pertaining to the appropriate claims of the invention.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed:

1. An image pickup method, comprising:
picking up images of the periphery of said vehicle using a plurality of cameras;
acquiring a global position of said vehicle;
acquiring a global direction of said vehicle;
acquiring a road information of the periphery of said vehicle;
selecting the images for said camera to be used based on the position of each camera on said vehicle, said global position, said global direction and said road information and
displaying the selected image or plurality of images to the driver of said vehicle.

2. The image pickup method described in claim 1, and further comprising:
detecting a display starting point to begin displaying said images picked up by said plurality of cameras to the driver of said vehicle;
detecting conditions in which said vehicle enters said road at said display starting point;
adjusting said displayed image range in accordance with said detected conditions; and
displaying said adjusted image range.

3. The image pickup method described in claim 2, wherein said entry conditions are the entry direction, entry angle and position of said vehicle in relation to the extended direction of said road.

4. The image pickup method described in claim 2, wherein said plurality of cameras comprises side cameras disposed on both sides of said vehicle and a front camera disposed at the front of said vehicle, and further comprising:
displaying the image picked up by said front camera first when said vehicle enters the road in a forward-moving direction; and
displaying the image picked up by said side camera when an image of one side of said road cannot be picked up by said front camera.

5. The image pickup method described in claim 2, and further comprising:
creating and displaying a composite image of the plurality of images when said plurality of images picked up by said plurality of cameras include an overlapping portion in said image range.

6. The image pickup method described in claim 2, wherein said plurality of cameras comprises side cameras disposed on both sides of said vehicle and a rear camera disposed at the rear of said vehicle, and further comprising:
creating and displaying a composite image of the image picked up by said side cameras and the image picked up by said rear camera when said vehicle enters the road in a reverse direction.

7. The image pickup method described in claim 1, and further comprising:
selecting one or more cameras in accordance with said entry conditions that are present while said vehicle is in the process of entering said road as well as after said vehicle has entered said road.

8. The image pickup method described in claim 7, and further comprising:
selecting the images for the selected cameras based on the straight-line distance between each camera on said vehicle and the road, the target range that is determined from the relationship between said vehicle and the road and the image pickup range for each camera on the said vehicle.

9. The image pickup method described in claim 8, and further comprising:
setting a priority for each camera so that the camera at the shortest distance has the highest priority.

10. The image pickup method described in claim 7, and further comprising:
determining a positional relationship for the display with consideration made to the positional relationship of the selected one or more cameras.

11. An image pickup device to obtain the periphery of a vehicle, comprising:
a plurality of cameras to pick up images of the periphery of said vehicle;
a starting point detection portion to detect the display starting point to begin displaying said images picked up by said plurality of cameras to the driver of said vehicle;
an entry conditions detecting portion to detect the conditions in which said vehicle enters said road at said display starting point that is detected by said starting point detecting means;
an image range adjusting portion to adjust said displayed image range in accordance with said entry conditions detected by said entry condition detecting means; and
a display to display said image range that is adjusted by said image range adjusting means.

12. The image pickup device described in claim 11, wherein said entry conditions are the entry direction, entry angle and position of said vehicle in relation to the extended direction of said road.

13. The image pickup device described in claim 11, wherein said plurality of cameras comprises side cameras disposed on both sides of said vehicle and a front camera disposed at the front of said vehicle and when said vehicle enters the road in a forward-moving direction, first the image picked up by said front camera is displayed and if an image of one side of said road cannot be picked up by said front camera, then the image picked up by said side camera is displayed.

14. The image pickup device described in claim 12, wherein said plurality of cameras comprises side cameras disposed on both sides of said vehicle and a front camera disposed at the front of said vehicle and when said vehicle enters the road in a forward-moving direction, first the image picked up by said front camera is displayed and if an image of one side of said road cannot be picked up by said front camera, then the image picked up by said side camera is displayed.

15. The image pickup device described in claim 11 wherein when said plurality of images picked up by said plurality of cameras include an overlapping portion in said image range adjusted by said image range adjusting portion, said display creates and displays a composite image of said plurality of images.

16. The image pickup device described in claim 12 wherein when said plurality of images picked up by said plurality of cameras include an overlapping portion in said image range adjusted by said image range adjusting portion, and said display creates and displays a composite image of said plurality of images.

17. The image pickup device described in claim 13 wherein when said plurality of images picked up by said plurality of cameras include an overlapping portion in said image range adjusted by said image range adjusting portion, and said display creates and displays a composite image of said plurality of images.

18. The image pickup device described in claim 14 wherein when said plurality of images picked up by said plurality of cameras include an overlapping portion in said image range adjusted by said image range adjusting portion, and said display creates and displays a composite image of said plurality of images.

19. The image pickup device described in claim 15 wherein said plurality of cameras comprises side cameras disposed on both sides of said vehicle and a rear camera disposed at the rear of said vehicle and when said vehicle enters the road in a reverse direction said display creates and displays a composite image of the image picked up by said side cameras and the image picked up by said rear camera.

20. The image pickup device described in claim 11 wherein said periphery image pickup devices that obtain said images to display to the driver of said vehicle and the image range of the images obtained by the periphery image pickup devices that are displayed to the driver of the vehicle are selected in accordance with said entry conditions that are present while said vehicle is in the process of entering said road as well as after said vehicle has entered said road.

21. The image pickup device described in claim 11, and further comprising:
a vehicle position acquiring portion for acquiring the global position of said vehicle;
a vehicle direction acquiring portion for acquiring the global direction of said vehicle;
a road information acquiring portion for acquiring road information for the periphery of said vehicle; and
an image selecting portion for selecting the images for said camera to be used based on the position of each camera on said vehicle, said global position, said global direction and said road information.

22. The image pickup device described in claim 21 wherein said image selecting portion selects the images for said cameras based on the straight-line distance between each camera on said vehicle and the road, the target range that is determined from the relationship between said vehicle and the road and the image pickup range for each camera on the said vehicle.

23. The image pickup device described in claim 22 wherein for said image selecting portion, the priority is set for each camera so that the camera at the shortest distance has the highest priority.

24. The image pickup device described in claim 23 wherein each of said target range and said image pickup range are only represented as an angle.

25. The image pickup device described in claim 21 wherein said display determines the positional relationship for the display with consideration made to the positional relationship of the original camera when displaying images selected by said image selecting portion.

26. The image pickup device described in claim 22 wherein said display determines the positional relationship for the display with consideration made to the positional relationship of the original camera when displaying images selected by said image selecting portion.

27. The image pickup device described in claim 23 wherein said display determines the positional relationship for the display with consideration made to the positional relationship of the original camera when displaying images selected by said image selecting portion.

28. The image pickup device described in claim 24 wherein said display determines the positional relationship for the display with consideration made to the positional relationship of the original camera when displaying images selected by said image selecting portion.
